(19) United States
(12) Patent Application Publication
(10) Pub. No.: US 2011/0002536 A1
(43) Pub. Date: Jan. 6, 2011

(54) MULTISPECTRAL NATURAL FIBER QUALITY SENSOR FOR REAL-TIME IN-SITU MEASUREMENT

(75) Inventors: J. Alex Thomasson, Hearne, TX (US); Ruixiu Sui, Leland, MS (US)

Correspondence Address: CHALKER FLORES, LLP, 2711 LBJ FRWY, Suite 1036, DALLAS, TX, 75234, US

(73) Assignee: THE TEXAS A&M UNIVERSITY SYSTEM, College Station, TX (US)

(21) Appl. No.: 12/829,382

(22) Filed: Jul. 1, 2010

Related U.S. Application Data
(60) Provisional application No. 61/222,480, filed on Jul. 1, 2009.

(51) Int. Cl. G06K 9/00; G06F 19/00; G01J 3/00

(52) U.S. Cl. 382/165; 702/25; 702/76

(57) ABSTRACT

A computerized method and sensor for real-time in-situ measurement of a quality of fibers within a sample containing extraneous material is described herein. The fibers can be cotton, jute, flax, ramie, sisal, hemp, silk, wool, catgut, angora, mohair, alpaca or other natural fiber. The fibers are differentiated from the extraneous material within the sample. One or more positions of the fibers are determined. A multi-spectral reflectance of the fibers at the one or more positions at two or more near infrared wavebands is measured wherein each waveband has a central wavelength and a bandwidth. The two or more central wavelengths are within a range of approximately 1100 nm to 2400 nm, and the bandwidth is within a range of approximately 10 nm to 100 nm. A micronaire level for the fibers is determined based on the measured multi-spectral reflectance.

### CROSS-REFERENCE TO RELATED APPLICATIONS

This application claims benefit of U.S. Provisional Application Ser. No. 61/222,480 filed Jul. 1, 2009 which is incorporated herein by reference in its entirety.

### TECHNICAL FIELD OF THE INVENTION

The present invention relates in general to the field of natural fibers, and more specifically to the design, development, and application of a multispectral sensor for measuring natural fiber quality properties.

### STATEMENT OF FEDERALLY FUNDED RESEARCH

None.

### BACKGROUND OF THE INVENTION

Without limiting the scope of the invention, its background is described in connection with sensors for measuring the properties of natural fibers and more specifically cotton fibers.

Cotton fiber quality is becoming one of the most important issues in cotton production because of its large effect on the price producers receive for their cotton. For optimum profitability, cotton producers must have a success on both the yield and quality of the crop. Precision agriculture technologies provide opportunities for improvement of cotton fiber quality through optimizing crop management. Just as cotton yield maps have been essential to understand spatial relationships between field-management practices and the crop yield, so also are cotton fiber quality maps required to understand relationships between field-management practices and the fiber quality. However, there are no cotton fiber quality sensors available for field use on harvesters, so efficient generation of cotton fiber quality maps is currently impossible.

Researchers have conducted experiments using hand harvesting and laboratory measurements to find that spatial variability in cotton fiber quality and significant correlations between crop growth conditions and fiber quality exist within a field. Elms et al. (2001) measured spatial variability of fiber quality in an irrigated cotton field at Lubbock, Tex. for three consecutive growing seasons. They found that during the three growing seasons the fiber micronaire varied from 3.9 to 6.1, fiber length from 24 to 30 mm, and fiber strength from 27.9 to 56.0 g/tex. Johnson et al. (1998) measured spatial variability of cotton fiber quality in a field at Florence, S.C. The results showed that the short fiber content and micronaire exhibited substantial variability, with ten percent of samples in the micronaire price penalty range. Guo et al. (2004) studied the spatial variability of cotton fiber quality within a 40-ha field near Plainview, Tex. for two years and found that micronaire varied from 4.0 to 5.3 in 2001 and from 3.1 to 5.0 in 2002. Wang (2004) reported spatial variability of micronaire from 3.1 to 5.1 in two Mississippi cotton fields. Ge et al. (2006) reported that soil moisture content was strongly correlated with fiber length, strength, and length uniformity in irrigated cotton, and strongly correlated with micronaire and elongation in the non-irrigated cotton. Many studies showed that growth-environment fluctuations, both those resulting from seasonal and annual variability in weather conditions and those induced by cultural practices and inputs, have influence on fiber length (Bradow and Davidonis, 2000). In addition to evidence in the aforementioned studies, Ping et al. (2004) found sand and clay content, exchangeable Ca²⁺ and Mg²⁺, NO₃⁻, Olsen-P, pH, relative elevation, and slope to be related to yield and fiber quality.

These studies point to the potential of site-specific management and harvesting to optimize cotton quality and maximize producer's profit. One way to achieve this potential is to vary farming inputs such as water and fertilizer spatially according to fiber quality and other relevant factors within the field. Another strategy is to make use of existing fiber-quality variability by segregating the crop into categories as it is harvested. Often there is a portion of the crop that is of higher quality than the rest, and its value is usually averaged with the rest of the crop's. If the high quality portion could be segregated, it could be sold at a higher price, while the rest of the crop could be sold at its current value. To implement either the variable-rate application or segregation harvesting strategy, the main lacking ingredient is an efficient method of measuring fiber quality in the field.

Robust and accurate optical instruments can be designed, so they appear to be good possibilities for field fiber-quality sensing. Several studies have considered laboratory- or processing-plant-based optical measurements for fiber quality. Thomasson and Shearer (1995) used spectroscopic methods to analyze cotton quality characteristics. They found a strong correlation between near-infrared (NIR) reflectance of cotton fiber and micronaire (r²=0.96). Wang (2004) used the optical measurement techniques of diffuse reflectance and transmittance in the near- and mid-infrared ranges to develop sensor technologies for cotton fiber micronaire measurement. He found a strong correlation (r²=0.92) between near- and mid-infrared spectra and micronaire. Montalvo and Hoven (2004) reported their research on measurement of cotton micronaire, maturity and fineness using both an NIR instrument and a Micromat Fineness and Maturity tester. They found that the NIR method was more accurate and easier to use. In order to study the spatial variability of cotton fiber quality, Sassenrath et al. (2005) developed a rapid sampling system to collect portions of cotton during mechanical harvest by diverting cotton flow from a chute of cotton picker. The sampling system also recorded spatial information of the samples for creating fiber quality maps. Anthony (1992) patented a system for analyzing cotton as it flows through a gin. The system used a plate to capture and press the cotton against the interior surface of a window on a conduit to form a face of uniform cotton density for fiber property analysis.

### SUMMARY OF THE INVENTION

The present invention describes a multispectral sensor capable of measuring one or more fiber quality properties, including micronaire/maturity, for any type of natural fiber, (e.g., cotton, jute, flax, ramie, sisal, hemp, silk, wool, catgut, angora, mohair, alpaca or other natural fiber). For example, fiber quality is very important in cotton production, however spatial variability in fiber quality exists in cotton fields, therefore site specific optimization would be feasible. The present invention addresses this need by developing a sensor for real-time in-situ measurement of cotton fiber quality. The sensor can be installed on cotton harvesters, cotton ginning systems, or other similar equipment so that cotton fiber quality can be measured in real time in-situ.

In one embodiment, the present invention provides a computerized method for real-time in-situ measurement of a quality of fibers within a sample containing extraneous material in accordance with one embodiment of the present invention. The fibers can be cotton, jute, flax, ramie, sisal, hemp, silk, wool, catgut, angora, mohair, alpaca or other natural fiber. The fibers are differentiated from the extraneous material within the sample. One or more positions of the fibers are determined. A multi-spectral reflectance of the fibers at the one or more positions at two or more near infrared wavebands is measured wherein each waveband has a central wavelength and a bandwidth. The two or more central wavelengths are within a range of approximately 1100 nm to 2400 nm, and the bandwidth is within a range of approximately 10 nm to 100 nm. A micronaire level for the fibers is determined based on the measured multi-spectral reflectance. The foregoing steps are preformed in real-time in-situ using a processor.

In another embodiment, the present invention provides a computerized method for real-time in-situ measurement of a quality of fibers within a sample containing extraneous material in accordance with one embodiment of the present invention. The fibers can be cotton, jute, flax, ramie, sisal, hemp, silk, wool, catgut, angora, mohair, alpaca or other natural fiber. An image of the sample is captured in a visible waveband and two or more near infrared wavebands wherein each near infrared waveband has a central wavelength and a bandwidth. The two or more central wavelengths are within a range of approximately 1100 nm to 2400 nm, and the bandwidth is within a range of approximately 10 nm to 100 nm. One or more pixels are identified within the captured visible waveband image corresponding to the extraneous material using a visible band histogram. The captured near infrared waveband images are adjusted by removing the identified pixels corresponding to the extraneous material from the captured near infrared waveband images. A near infrared histogram is calculated for each adjusted near infrared waveband image. A maximum frequency pixel value is identified in each near infrared histogram. One or more pixel values within a specified pixel value range around the identified maximum frequency pixel value are extracted in each near infrared histogram. An average pixel value for the extracted pixel values for each near infrared histogram is calculated. A micronaire level for the fibers based on the calculated average pixel values is determined. The foregoing steps are preformed in real-time in-situ using a processor.

In addition, the present invention provides a multispectral sensor that includes a sensor enclosure, one or more optical sensors disposed within the sensor enclosure to record one or more images of the sample, one or more light sources disposed within the sensor enclosure, and a processor communicably coupled to the one or more optical sensors 1504. The processor can be configured to perform the methods described below in reference with FIG. 13 or 14, or combinations thereof.

### BRIEF DESCRIPTION OF THE DRAWINGS

For a more complete understanding of the features and advantages of the present invention, reference is now made to the detailed description of the invention along with the accompanying figures and in which:

FIG. 1 is a graph showing the Reflectance spectra of micronaire cotton standards (shown top to bottom: Gm-10, Cm-19, Dm, Bm-2, Im-37, Am-8);

FIG. 2 is a schematic diagram of the multispectral sensor in accordance with one embodiment of the present invention;

FIG. 3 is a graph showing the spectral response of optical filters FB1450-12, FB1550-12, and FB1600-12 used on the multispectral sensor in accordance with one embodiment of the present invention;

FIG. 4 is a graph showing the distributions of image pixel values for the International Calibration Cotton Standard (ICCS) GM-10 at wavelength of 1550 nm;

FIG. 5 is a plot of the actual versus predicted micronaire values using regression model containing all three wavebands (1450, 1550, and 1600 nm) of region of interest data in accordance with one embodiment of the present invention;

FIG. 6 is a plot of the actual versus predicted micronaire values using regression model containing two wavebands (1550 and 1600 nm) of histogram data in accordance with one embodiment of the present invention;

FIG. 7 is a seed-cotton image in the visible band in accordance with the present invention;

FIG. 8 is a seed-cotton image histogram of pixel values in the visible band range in accordance with the present invention;

FIG. 9 is an adjusted image wherein the non-lint pixels are identified in the visible seed-cotton image and the non-lint/trash are indicated by the black pixels in accordance with the present invention;

FIG. 10 is an adjusted seed-cotton image histogram of the 1450 nm band image in accordance with the present invention;

FIG. 11 is an adjusted seed-cotton image histogram of the 1550 nm band image in accordance with the present invention;

FIG. 12 is an adjusted seed-cotton image histogram of the 1600 nm band image in accordance with the present invention;

FIG. 13 is a flow chart of a method for real-time in-situ measurement of a quality of fibers within a sample containing extraneous material in accordance with one embodiment of the present invention;

FIG. 14 is a flow chart of a method for real-time in-situ measurement of a quality of fibers within a sample containing extraneous material in accordance with one embodiment of the present invention;

FIG. 15 is a block diagram of a multispectral sensor in accordance with one embodiment of the present invention; and

FIG. 16 is a schematic diagram of a multispectral sensor in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention describes the design, development, and application of a multispectral sensor capable of measuring one or more cotton fiber quality properties, including micronaire/maturity. The sensor of the present invention can be installed on cotton harvesters, cotton ginning systems, or other similar equipment so that cotton fiber quality can be measured in real time in-situ.

The present invention describes an opto-electronic sensor to measure cotton fiber properties as cotton is harvested in the field, and to ultimately create a fiber quality maps for development of fiber-quality based site-specific management strategies. The present disclosure details the development of the multispectral sensor of the present invention and the results obtained for micronaire determination using the said sensor.

Spectral reflectance of lint cotton was measured with a Cary 500 UV/Vis/NIR spectrophotometer (Varian Inc., Palo Alto, Calif.) at wavelength range from 250 to 2500 nm. The spectrophotometer is equipped with a diffuse-reflectance accessory that incorporates an integrating sphere. Due to its geometry, the integrating sphere is able to collect almost all the reflected radiation from the object measured, remove any directional preferences, and present an integrated signal to the detector of spectrophotometer. The collected spectrum for each lint sample consisted of 1045 reflectance values, each with an averaging time of 0.1 s. The spectral resolution selected in the 250 to 892 nm range was 1 nm, and that used in the 892 to 2500 nm range was 4 nm.

Six types of international calibration cotton standard (ICCS) (Cotton Program, USDA, Memphis, Tenn.) were chosen for the spectral measurement. They were Am-8, Bm-2, Cm-19, Dm, Gm-10, and Im-37, with micronaire values of 5.58, 4.58, 3.41, 4.03, 2.67, and 5.03, respectively. Five samples were randomly taken from each ICCS to make a total of 30 samples for spectral measurement. Each sample weighed 300 mg, and the volume of each was such that it could be inserted into a sampler holder with little pressure.

A plastic sample holder was designed and fabricated specifically so that cotton samples could be presented to the spectrophotometer. The sample holder was 20 mm tall, 26 mm in outside diameter, and 20 mm in inside diameter. It had a window at one end and a removable cap at the other end. The window was a piece of sapphire glass with a thickness of 1 mm and a diameter of 22 mm. Sapphire was chosen because its transmission from 200 to 6000 nm is roughly constant.

Baseline correction was used in spectral data collection. A spectral reflectance baseline was recorded with a reference disk before collecting cotton reflectance spectra. The reference disk in this case was a manufacturer-provided polytetrafluoroethylene (PTFE) disk. In order to account for the light attenuation caused by the optical window in the sample holder, the same type of sapphire glass as used in the sample holder was placed on top of the PTFE disk during baseline collection. Cotton samples were prepared by inserting each 300-mg sample of lint into the sample holder. The cotton was retained in the holder by placing the removable cap over the open end of the holder. Each cotton sample was then mounted over the sample port of the spectrophotometer with the sample holder's window pressed against the sample port. The integrating sphere then collected the energy reflected from the cotton sample surface. One spectral measurement was taken for each sample.

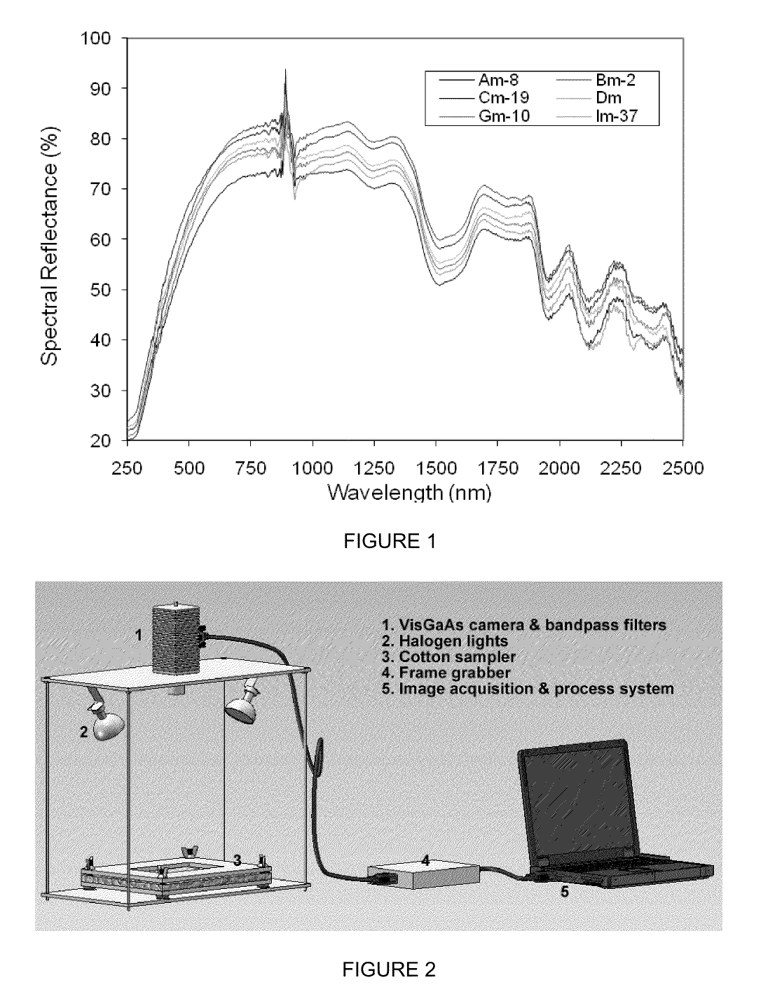

The relationship between micronaire and spectral reflectance was evaluated with multiple regression models. As shown in FIG. 1, the spectral graphs that the reflectance spectra varied significantly with micronaire in the NIR region while changing little in the ultra-violet and visible wavebands. Thus the NIR region was the selected waveband for the purpose of the present invention, and UV-Vis wavelength region was not used to develop the sensor of the present invention for micronaire measurement. These results are consistent with previous reports in the literature (Thomasson and Shear, 1995; Wang, 2004). Thus seven wavebands in the NIR region, each with a bandwidth of 100 nm, were identified from each sample spectrum for model development. The central wavelengths for the 100-nm wavebands were 1120, 1296, 1550, 1664, 1852, 2020, and 2340 nm. An average reflectance value was calculated for each 100-nm waveband. These 100-nm average values were analyzed with the SAS® procedure, PROC REG (SAS®, Triangle Research Park, N.C.) in order to determine correlations between spectral reflectance and micronaire.

The spectral data were also analyzed with the wavelet analysis method (Ge et al., 2006; Ge et al., 2007). Since the NIR range appeared promising, and since a detector with a wavelength range of roughly 1000 to 1700 nm was being considered for sensor development, the original fiber spectra were reduced to a range from 1000 to 1700 nm. Spline interpolation was implemented with MATLAB (version 7.0) to re-sample the truncated spectra at a rate of 5.51 nm, resulting in 128 (700/(5.51+1)) sampling units in each reflectance spectrum. This method facilitated dyadic wavelet decomposition. Each reflectance spectrum was then subjected to 5 levels of dyadic wavelet decomposition. Approximation coefficients at scales five, four, three, and two, which corresponded to bandwidth of 4, 8, 16, and 32 sampling units [or 22 (4×5.51), 44 (8×5.51), 88 (16×5.5) and 176 (32×5.5) nm], respectively, were extracted for multiple regression analysis. This yielded a total of 60 variables in the wavelet domain. The mother wavelet used was the Haar wavelet, and wavelet decomposition was performed with the MATLAB (Version 7.0) Wavelet Toolbox. Multiple regression analysis was then performed with SAS procedure PROC REG to regress micronaire (dependent variable) against the approximation coefficients (independent variables). The STEPWISE variable selection criterion was used. The level of significance to include a variable in and remove it from the model was set at 0.25.

Based on the spectroscopic study described above, a prototype of camera-based multispectral sensor was built for determining fiber quality. A schematic representation of the sensor is shown in FIG. 2. The sensor 2 consists of an Alpha VisGaAs camera and optical filters 4, halogen light source 6, a sample holder 8, an image frame grabber 10, and an image analyzer 12 (FIG. 2). The camera with the filters 4 is connected to the image frame grabber 10 through a wire (connection/cable) 14. The image frame grabber 10 is connected to the image analyzer (typically a laptop or desktop computer) through a connection 16. The camera with a filter 4 was set up faced down toward cotton sample holder 8. Cotton fiber images acquired by the camera 4 were input through an image frame grabber board 8 (IMAQ PCI-1422, National Instruments, Austin, Tex.) into an image analyzing system 12. A laptop computer was used as an image analyzer 12 in the system to collect, record, and analyze the images. The halogen lamps 6a and 6b, and the sample holder 8 are placed inside an enclosure or casing 18. The camera is attached to the top of the casing 18.

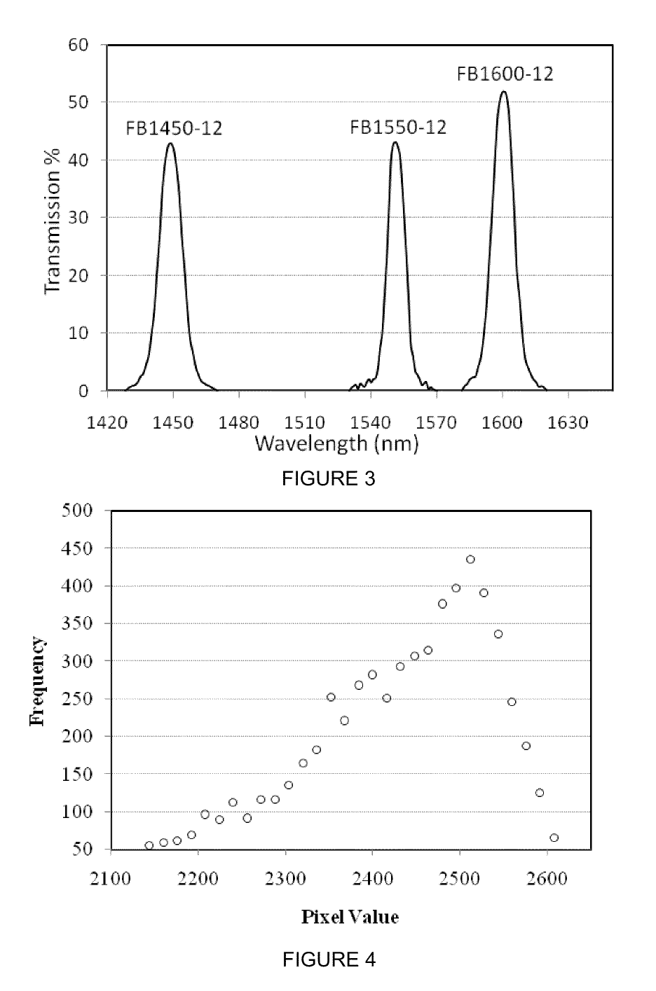

The camera 4 used in the multispectral sensor was a product of FLIR Systems, Inc. (Goleta, Calif.). It was able to capture images simultaneously in both the visible and NIR spectral region (from 400 to 1700 nm). With a frame grabber board 8 and a digital interface cable 14 the camera system could output real-time, 12-bit digital image data at 30-Hz frame rate and allow the user to conduct camera control including integrating time, gain state, and other camera-detector parameters. The lens used in the camera 4 was an 8 mm lens with a wide angle (61.9×51.3 degrees field of view). Distance between camera lens and cotton sample was 445 mm. Three optical bandpass filters (FB1450-12, FB1550-12, FB1600-12) manufactured by Thorlabs Inc. (Newton, N.J.) were employed for collecting images at selected wavelength region. The central wavelengths of the filters are 1450, 1550, and 1650 nm with 12 nm FWHM (full width at half maximum), respectively. FIG. 3 shows the spectral responses of the filters. All filters are 6.3 mm thick with a diameter of 25.4 mm. In combination of the camera with these bandpass filters, the sensor was able to acquire the images at each selected narrow waveband that is sensitive to cotton fiber quality such as micronaire. In current prototype sensor, as shown in FIG. 2 a selected filter was manually installed in front of camera lens before image acquisition. In the complete sensor system, the filters can be automatically changed by an automated control device. Two halogen bulbs 6a and 6b were implemented for sufficient light source required to illuminate cotton fiber during image acquisition. The halogen lamp (MR-16, USHIO, Cypress, Calif.) was 20 W with a frontline reflector to provide diffused light. Color temperature of the lamps is 2900 K. Two bases were fabricated for mounting the lamps so that the angles of lamp radiation to cotton sample could be adjustable to avoid “hot” spots in images.

The sample holder 8 was designed and fabricated to hold a fiber sample as the images were acquired. The holder consisted of two equal size plates. The top plate was a 152×152 mm optical window 8h glued on a PVC frame. The bottom one was simply a 230×230 PVC board with a thickness of 6.3 mm. There was one hole drilled at each corner of the plates. Cotton sample could be laid between the plates. Butterfly nuts and screws through the holes were used to fasten the top 8a and the bottom plates together and press a lint sample between tightly to avoid shade in the sample as it was illuminated by the halogen lights 6. The optical window 8h was a piece of 3 mm thick Borofloat glass. This glass has a 91% of transmittance in a wavelength range from 400 to 2000 nm, which allows collecting images in visible and NIR region.

The prototype of multispectral sensor for cotton fiber quality measurement was evaluated in laboratory. Cotton samples used in the test were six types of ICCS (Am-8, Bm-2, Cm-19, Dm, Gm-10, and Im-37), which were the same as that used in spectroscopic measurement to determine the fiber-quality sensitive wavebands. A hundred gram of lint sub-sample was randomly taken from each type of the ICCS. In preparing a sample, firstly the 100 g lint was evenly laid on the bottom plate of the sample holder, then placed the top part of the sample holder on the lint layer and fasten the two plates together by hand-turning the butterfly nut on the screw at each corner of the sample holder. Prepared sample was placed under the camera as shown in FIG. 2 for measurements. The halogen lamps were powered by a 9V DC power supply and the other devices in the sensor used 120V AC with their power adaptors. The sensor was turned on for 30 minutes before acquiring images. This “warm-up” time was required for the halogen lights in the sensor to get stabilized to provide a consistent light intensity. The camera, halogen lights, and the sample were enclosed into a box to prevent the sensor from interference of ambient light sources. In order to avoid light reflectance inside the box, insides of the box were painted black.

IRVista software (Indigo Systems Corp) was used with the sensor for acquisition and analysis of cotton fiber images. The software was installed in a Dell laptop computer with a Windows XP operation system. IRVista is a software package based on National Instruments LabVIEW. It is a real-time image acquisition and analysis application that provides the user with acquisition, storage, retrieval, display, processing, and analysis of still images and video in a Windows interface. During the image acquisition, integrating time of 5,000 microsecond and high gain model were selected through IRVista software to control the camera. While a cotton sample was placed under the camera, the sensor in live operating mode acquired and displayed instantaneous cotton images at a rate of 14 frames per second. After clicking on the “freeze” button on the application window of IRVista, an image was frozen to be still for analysis. Analysis tool of ROI (Region of Interest) in IRVista software was used to compute pixel value in a selected region of the frozen image. Pixel numbers and the maximum, minimum, and average pixel values of each selected region were recorded. Three regions were randomly selected around the central area of each image. That totaled 54 regions for 6 cotton samples and three wavebands. One set of Histogram data was collected for each sample at each waveband. That gave 18 histograms in total. FIG. 4 shows the distribution of image pixel value of a histogram. Data of the selected image regions (referred as ROI data) and the data of histogram were analyzed separately. Pixel value of ROI data were analyzed using the SAS® procedure, PROC REG (SAS®, Triangle Research Park, N.C.) to determine the relationship between image pixel value of cotton fiber and the fiber's micronaire. Maximum pixel frequency in the histogram was identified in histogram data processing. Pixels centered at the maximum pixel frequency within a pixel value range of 496 were extracted and their average pixel value was computed. Multiple linear regression was performed to find the relationship between the pixel value and the micronaire value of fibers.

Spectra collected from the cotton samples with different micronaire values were shown in FIG. 1. Each spectrum represents the average of the five replicates. Obvious noise spike near the wavelength of 900 nm was caused by a change in light source inside the spectrophotometer.

It was evident that the reflectance spectra demonstrated a high level of variation in the NIR band while showing very little change in the visible region. In general, cotton fibers with lower micronaire reflected more NIR energy. Multiple linear regression models for micronaire, developed with the SAS REG procedure, were given in Table 1. These models show that micronaire had a strong correlation (r²=0.89) with reflectance in the seven 100-nm wavebands. Micronaire can be predicted very well (r²=0.88) even when using a model involving only two wavebands as independent variables. The waveband centered at 1500 nm was the most informative single band for micronaire determination in this case.

Results of relating micronaire to 100-nm averaged cotton reflectance spectra using multiple linear regression (n=30) are shown below in Table 1:

| Var. No. | Central wavelength | |
|---|---|---|
| In Model | included in models (nm) | R² |
| 1 | 1500 | 0.873 |
| 1 | 1664 | 0.841 |
| 1 | 1296 | 0.817 |
| 2 | 1500, 1664 | 0.880 |
| 2 | 1500, 2340 | 0.877 |
| 2 | 1296, 1500 | 0.875 |
| 3 | 1500, 1664, 2340 | 0.884 |
| 3 | 1500, 1664, 2020 | 0.882 |
| 3 | 1500, 1664, 1852 | 0.881 |
| 4 | 1120, 1500, 1664, 2340 | 0.886 |
| 4 | 1296, 1500, 1664, 2340 | 0.885 |
| 4 | 1120, 1500, 1664, 2020 | 0.885 |
| 5 | 1120, 1500, 1664, 1852, 2340 | 0.888 |
| 5 | 1120, 1296, 1500, 1664, 2340 | 0.887 |
| 5 | 1120, 1500, 1664, 2020, 2340 | 0.887 |
| 6 | 1120, 1296, 1500, 1664, 1852, 2340 | 0.889 |
| 6 | 1120, 1296, 1500, 1664, 2020, 2340 | 0.888 |
| 6 | 1120, 1500, 1664, 1852, 2020, 2340 | 0.888 |
| 7 | 1120, 1296, 1500, 1664, 1852, 2020, 2340 | 0.889 |

In the wavelet analysis, six wavelet regressors were included in the calibration model (Table 2). They were F25 centered at 1550 nm with a bandwidth of 44 nm; F9 centered at 1395 nm with a bandwidth of 88 nm; F51 at 1450 nm with a bandwidth of 22 nm; F49 at 1495 nm with a bandwidth of 22 nm; F56 centered at 1605 nm with a bandwidth of 22 nm; and F57 at 1627 nm with a bandwidth of 22 nm. The bands in the best three-band model were centered at 1605, 1550, and 1450 nm with bandwidths of 22, 44, and 22 nm, respectively. This result was similar to that obtained with the multiple linear regression analysis mentioned above. The calibration model established with wavelet analysis showed a very strong correlation between spectral reflectance and micronaire (Table 2). R-squared values of the six selected models ranged from 0.94 to 0.97, which were much higher than those obtained with the multiple linear regression method. The reason for the difference was probably related to the fact that the bandwidths of regressors in the wavelet method were typically much narrower than the 100-nm bandwidth used with the other method. However, the bandwidth (from 22 to 100 nm) selected in both methods was practical for development of the optical fiber quality sensing sensor.

Results of relating micronaire to wavelet regressors using multiple linear regression (n=30) are shown below in Table 2:

| Var. No. | Variable | Central wavelengths (nm) | R² |
|---|---|---|---|
| 1 | F56 | 1605 | 0.936 |
| 2 | F56, F25 | 1605, 1550 | 0.942 |
| 3 | F56, F25, F51 | 1605, 1550, 1450 | 0.953 |
| 4 | F56, F25, F51, F9 | 1605, 1550, 1450, 1395 | 0.956 |
| 5 | F56, F25, F51, F9, F49 | 1605, 1550, 1450, 1395, | 0.961 |
| | | 1495 | |
| 6 | F56, F25, F51, F9, F49, | 1605, 1550, 1450, 1395, | 0.968 |
| | F57 | 1495, 1627 | |

Wavelet regressors are computed with dyadic wavelet analysis of cotton sample reflectance spectra.

Results from both analysis methods indicated that a model involving one to three selected wavebands could make an accurate determination for fiber micronaire, and the prediction accuracy of the model would not be improved much by adding more wavebands (Tables 1 and 2). Though the wavebands centered at 2020 nm and 2340 nm were sensitive to micronaire as well, the cost of opto-electronic detectors in that wavelength region is much higher than the cost of detectors in the wavelength of 1700 nm or shorter. These observations would be very useful in simplifying the design of the fiber quality sensor.

A camera-based multispectral sensor was developed based on the reflectance characteristics determined using a UV-Vis-NIR Spectrophotometer. The sensor was capable to acquire images at three NIR wavebands (1450, 1550, and 1600 nm) with bandwidth of 12 nm. The sensor was tested in lab with six types of ICCS. The testing results showed that the images pixels values were very strongly correlated with the micronaire of lint cotton (Tables 3 and 4). Table 3 summaries the measurement results of the lint samples at each waveband using ROI processing method. Each point of the pixel value in the table is the average reflectance of the sample in the selected image region. It was observed that there was a trend that the lint with higher micronaire has lower reflectance at all three NIR wavebands. This result was consistent with what was found in the study on determination of fiber quality sensitive-wavebands using UV-VIS-NIR spectrophotometer.

Micronaire of lint samples and their corresponding pixel values at various wavebands are shown below in Table 3:

| | | | Pixel | Pixel | |
|---|---|---|---|---|---|
| | | | value | value | |
| Lint | | Micronaire | @1450 | @1550 | Pixel value |
| sample | Replications | value | nm | nm | @1600 nm |
| AM-8 | 1 | 5.58 | 2122 | 2408 | 2425 |
| | 2 | 5.58 | 2127 | 2415 | 2422 |
| | 3 | 5.58 | 2119 | 2421 | 2416 |
| BM-2 | 1 | 4.58 | 2142 | 2432 | 2482 |
| | 2 | 4.58 | 2146 | 2449 | 2479 |
| | 3 | 4.58 | 2150 | 2428 | 2469 |
| CM-19 | 1 | 3.41 | 2164 | 2464 | 2509 |
| | 2 | 3.41 | 2158 | 2470 | 2512 |
| | 3 | 3.41 | 2151 | 2474 | 2513 |
| DM | 1 | 4.03 | 2138 | 2440 | 2500 |
| | 2 | 4.03 | 2152 | 2456 | 2509 |
| | 3 | 4.03 | 2138 | 2448 | 2514 |
| GM-10 | 1 | 2.67 | 2194 | 2499 | 2527 |
| | 2 | 2.67 | 2183 | 2501 | 2538 |
| | 3 | 2.67 | 2191 | 2507 | 2530 |
| IM-37 | 1 | 5.03 | 2126 | 2419 | 2469 |
| | 2 | 5.03 | 2128 | 2414 | 2472 |
| | 3 | 5.03 | 2130 | 2419 | 2478 |

The pixel values were calculated using Region of Interest (ROI) data of images acquired by the multispectral sensor.

Micronaire of lint sample and its corresponding pixel value at various wavebands are shown below in Table 4:

| Lint | Micronaire | Pixel value | Pixel value | Pixel value |
|---|---|---|---|---|
| sample | value | @1450 nm | @1550 nm | @1600 nm |
| AM-8 | 5.58 | 2084 | 2365 | 2385 |
| BM-2 | 4.58 | 2106 | 2397 | 2435 |
| CM-19 | 3.41 | 2117 | 2426 | 2468 |
| DM | 4.03 | 2105 | 2394 | 2457 |
| GM-10 | 2.67 | 2150 | 2454 | 2489 |
| IM-37 | 5.03 | 2062 | 2366 | 2423 |

The pixel value was calculated using histogram data of images acquired by the multispectral sensor.

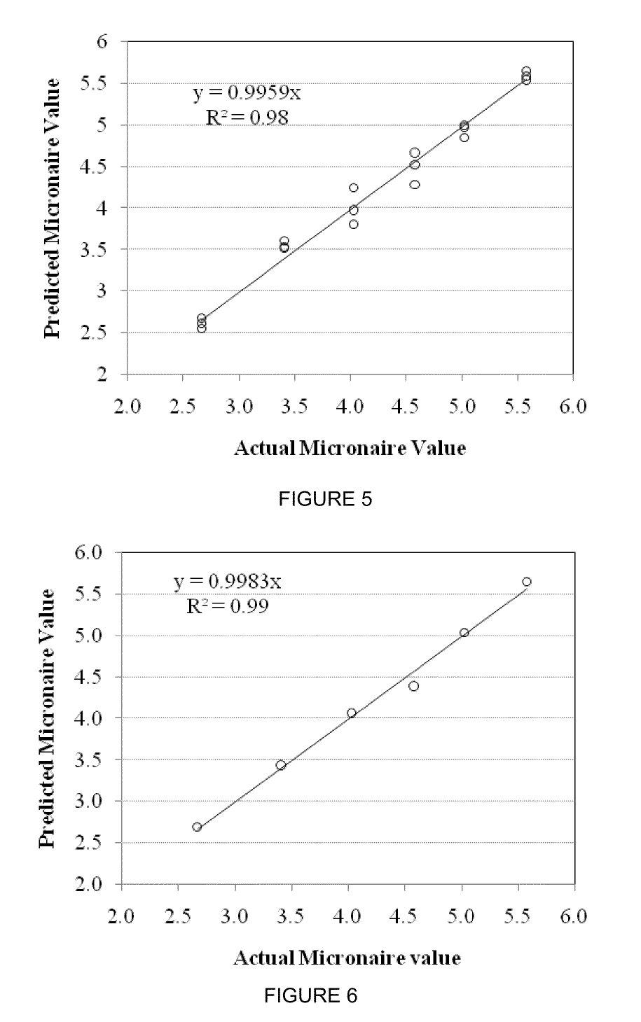

Regression analysis results (Table 5) indicated that micronaire has a very strong correlation with the pixel value (r²=0.98) as the three wavebands (1450 nm, 1550 nm, 1600 nm) are involved in the model. The correlation coefficient was as high as 0.93 even only 1550 nm waveband was used in the model. Compared with the 1550 nm and 1600 nm bands, the reflectance at 1450 nm has a weaker correlation with micronaire. The combination of bands 1550 nm and 1600 nm could be a practical option for micronaire measurement because the model with those two bands only has an r-square value of 0.98 which is as great as that of the model involving the three wavebands. Table 4 presents the pixel values that were calculated using image's histogram data. And the regression analysis results of image histogram data were given in Table 6. The results showed a very close correlation between micronaire and the pixel value as well, which is consistent to what it found using spectroscopic data and ROI data. Again, the model with 1550 nm and 1600 nm as variables showed the closest correlation between micronaire and the image (r²=0.99). The 1450 nm band was not as great as the other two bands in predicting micronaire. It was noticed that 1600 nm band showed a much stronger correlation with micronaire in histogram data (r²=0.96) than in the ROI data (r²=0.88). In general, the r-square value in Table 6 is higher than that in Table 5 as the same waveband variable was used the model. This could be partially due to that observations used in histogram data analysis (n=6) were less than that used in ROI data analysis (n=18). Results from both ROI data analysis and histogram data analysis suggested that the sensor still could do an excellent job in determining lint micronaire even only using two bands 1550 nm and 1600 nm. Predicted micronaire was calculated using a three-waveband (1450, 1550, and 1600 nm) model developed using ROI data and a two-waveband (1550 and 1600 nm) model using the histogram data. They were plotted versus the actual micronaire (FIGS. 5 and 6). It was indicated that the models preformed better in predicting the lower and higher micronaire. The prediction error was relatively larger with medium micronaire samples.

It was observed that in wavelet analysis of spectroscopic data the correlation of bands 1550 nm and 1605 nm with micronaire was a little bit weaker (r²=0.94, Table 2) than that of bands 1550 nm and 1600 nm (r²=0.98, Table 5) which was obtained in the analysis of ROI data. This could be due to the bandwidth used in the wavelet analysis was broader (44 nm for band 1550 nm, 22 nm for band 1605 nm) than the bandwidth used in the ROI data (12 nm). The narrow wavebands increased the sensitivity of the system. However, it should be pointed out that the narrower a bandwidth is, the less optical energy can be intercepted by the detector given a fixed dwelling time interval. It could be difficult to accurately measure a very weak optical signal. So, both the sensitivity of a system and the feasibility to achieve the target sensitivity should be considered and balanced in design of an optical sensor.

Results of regression analysis relating micronaire to image pixel data (Region of Interest) of images acquired by the multispectral sensor (n=18) are shown below in Table 5:

| Var. no. | | R- | | |
|---|---|---|---|---|
| in model | Variable | Square | RMSE | Pr > F |
| 1 | B1550 nm | 0.93 | 0.27 | <0.0001 |
| 1 | B1600 nm | 0.88 | 0.37 | <0.0001 |
| 1 | B1450 nm | 0.87 | 0.37 | <0.0001 |
| 2 | B1550 nm B1600 nm | 0.98 | 0.16 | <0.0001 |
| 2 | B1450 nm B1600 nm | 0.96 | 0.20 | <0.0001 |
| 2 | B1450 nm B1550 nm | 0.94 | 0.27 | <0.0001 |
| 3 | B1450 nm B1550 nm B1600 nm | 0.98 | 0.15 | <0.0001 |

Results of regression analysis relating micronaire to histogram data of images acquired by the multispectral sensor (n=6) are shown below in Table 6:

| Var. no. in | | R- | | |
|---|---|---|---|---|
| model | Variables | Square | RMSE | Pr > F |
| 1 | B1600 nm | 0.96 | 0.23 | 0.0005 |
| 1 | B1550 nm | 0.91 | 0.36 | 0.0032 |
| 1 | B1450 nm | 0.81 | 0.52 | 0.0141 |
| 2 | B1550 nm B1600 nm | 0.99 | 0.12 | 0.0006 |
| 2 | B1450 nm B1600 nm | 0.98 | 0.19 | 0.0025 |
| 2 | B1450 nm B1550 nm | 0.91 | 0.42 | 0.0275 |
| 3 | B1450 nm B1550 nm B1600 nm | 0.99 | 0.14 | 0.0104 |

Reflectance at 1450 and 1900 nm could be affected by the moisture content of the sample. However, the samples measured in the experiments were standard lint samples having been stored under the same low—humidity conditions for many months, and therefore they had similar moisture contents when the measurements were made. Thus, the experimental results obtained in this study were not affected by moisture content. If the sensor reported here is used to measure cotton fibers with different moisture contents, the moisture content must be measured and taken into consideration while developing sensing models, assuming wavebands at or near 1450 or 1900 nm are used. Nevertheless, the 1900 nm band would likely not be chosen to develop a sensor for cotton fiber quality at the present time because (1) bands at 1450, 1550, and 1600 nm are more sensitive to fiber quality, and (2) detectors sensitive at 1900 nm are more expensive. Furthermore, it may be possible to use only the 1550 and 1600 nm bands, because the model including only these bands estimated cotton micronaire very well. This multispectral sensor could be used with a GPS receiver for cotton fiber quality mapping in the field and potentially implemented on a cotton harvester for harvest segregation based on cotton fiber quality. If farm management practices are uniform across a field, then a map of cotton fiber quality variation within the field can provide understanding of how non—uniform growing conditions affect lint quality. For example, it is well known that pest pressure can be aggregated within a field, and many times crop managers are interested in determining pest population thresholds that may affect crop value (Morgan et al 2002a and 2002b). Having a map of lint quality and yield and knowing the pest pressure can provide information for management decisions concerning pesticide applications. It is also well known that soil variability is related with differences in fiber quantity, but the reasons for this relationship are less well understood. Having fiber quality maps for a field could facilitate understanding in this area. A study in an irrigated cotton field during a dry year showed a significant relationship between soil variability and lint yield and between soil variability and fiber quality (Morgan et al., 2008). A second year of the study was wet, and while a strong relationship between lint yield and soil still existed, there was a much weaker relationship between fiber quality and soil. Results from this study have led the researchers to investigate reducing planting density on soils with lower water—holding capacity in order to mimic the better growth conditions during the wetter year when the crop was less water stressed. In this case, knowing how lint quality responded to soil variability has led to a potential management practice for improving quality uniformity in a field based on soil type. With development of yield and quality sensors that can map yield and quality year after year, further observations can be made to better understand the soil—fiber quality interactions over time and throughout many soil types and environmental conditions.

Since the image acquisition was conducted under a well controlled environment, and image variation caused by change of operation conditions should be negligible, no reference images were collected in this study. Pixel values from the camera were directly used in the image processing (Tables 3 and 5).

For determining cotton fiber quality, reflectance spectra of cotton fiber samples having different micronaire levels have been measured with a spectrophotometer. It was observed, consistent with some literature on the subject, that cotton fibers with lower micronaire values reflect more energy at most wavelengths from 900 to 2500 nm. The relationship between micronaire and spectral reflectance was evaluated with multiple regression analysis. It was indicated that micronaire had a strong correlation with the reflectance values in seven wavebands in the wavelength range of 900 to 2500 nm. Micronaire could be predicted well even with a model involving only two wavebands as independent variables.

Based on the characteristics of the cotton fiber reflectance spectrum and the analysis model developed, the inventors have designed and developed a multispectral sensor and evaluated in laboratory for measuring cotton fiber quality. The sensor consists of a VisGaAs camera, three optical bandpass filters (1450 nm, 1550 nm, 1600 nm) with a bandwidth of 12 nm, halogen light source, fiber sample holder, and image collection and process device. The camera's image of cotton fiber was a measure of fiber reflectance at selected wavebands. The reflectance data were collected and processed to find correlation between fiber micronaire and image pixel value. Results showed fiber micronaire has a very strong correlation with the pixel values at wavebands 1550 nm and 1600 nm. The regression model developed using these two wavebands could predict fiber micronaire successfully (r²=0.99). The band 1450 nm was not as great as the other two wavebands used in this study though the reflectance at that waveband was also strongly correlated with fiber micronaire (r²=0.87). This multispectral sensor could be used along with a GPS receiver for cotton fiber quality mapping in the fields. It also could be implemented onto a cotton harvester to perform harvest segregation based on cotton fiber quality.

Using the present invention, four images of each seed cotton sample were taken in the visible and NIR (near-infrared: 1450-, 1550-, and 1600-nm) bands, respectively.

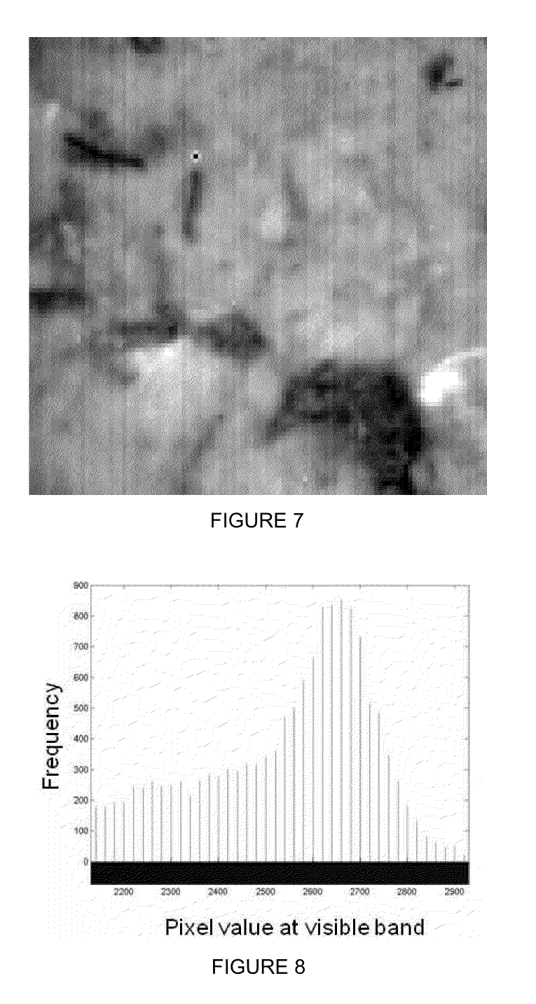

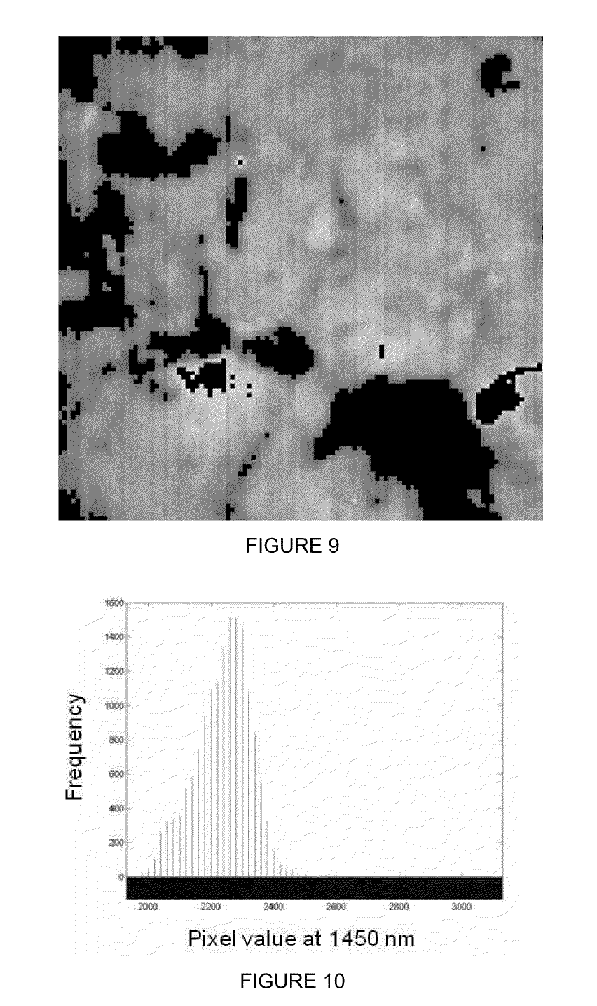

A histogram of the image in the visible band was used to remove the non-lint pixels from the images. FIG. 7 is a seed cotton image in the visible band. Undesirable (primarily non-lint) pixels were identified with a histogram (FIG. 8); pixels with values outside a selected range were regarded as non-lint pixels and removed from consideration so that only lint pixels would be used to determine cotton fiber quality. FIG. 9 is an image with undesirable pixels marked in black.

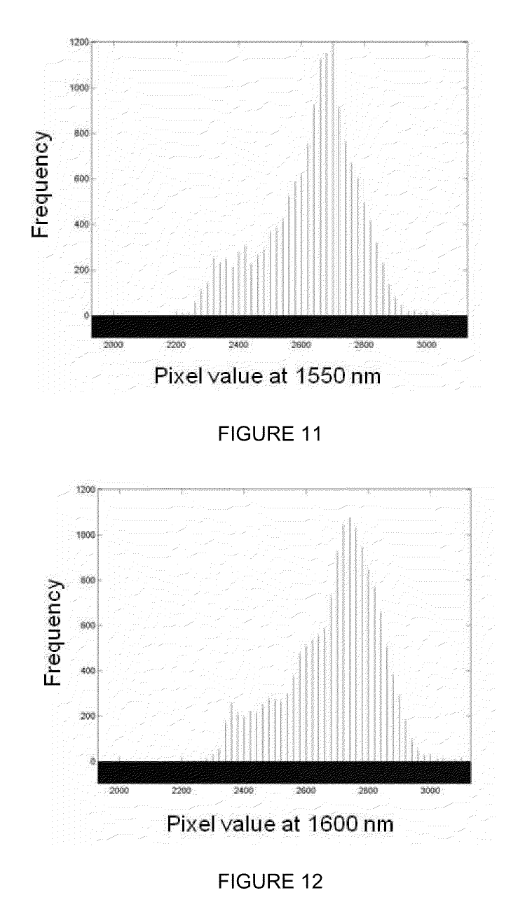

After undesirable pixels were removed from an image, histograms of the adjusted (i.e., with undesirable pixels removed) images in the NIR bands were calculated (FIGS. 10, 11, and 12).

The maximum-frequency pixel value in each NIR histogram was identified, pixel values within a certain pixel-value range around that value were extracted, and their average pixel value was computed (Table 7):

| Sample | Average Pixel Value | | |
|---|---|---|---|
| ID | 1450 nm Band | 1550 nm Band | 1600 nm Band |
| I-00 | 2286 | 2688 | 2729 |
| I-01 | 2266 | 2667 | 2726 |
| I-02 | 2280 | 2688 | 2760 |
| I-03 | 2270 | 2658 | 2721 |
| I-04 | 2242 | 2615 | 2693 |
| I-05 | 2257 | 2680 | 2726 |
| I-09 | 2273 | 2696 | 2749 |
| I-10 | 2292 | 2708 | 2772 |
| I-11 | 2293 | 2708 | 2781 |
| I-12 | 2283 | 2721 | 2773 |
| I-14 | 2287 | 2720 | 2757 |
| I-15 | 2296 | 2731 | 2782 |
| I-18 | 2273 | 2694 | 2743 |
| I-19 | 2250 | 2651 | 2709 |
| I-20 | 2283 | 2703 | 2762 |
| I-21 | 2250 | 2637 | 2668 |
| I-22 | 2258 | 2650 | 2702 |
| I-23 | 2276 | 2680 | 2740 |
| I-24 | 2242 | 2636 | 2688 |
| I-25 | 2247 | 2645 | 2690 |
| I-26 | 2290 | 2689 | 2750 |
| I-27 | 2282 | 2706 | 2747 |
| I-28 | 2286 | 2680 | 2748 |
| I-29 | 2267 | 2673 | 2736 |
| I-30 | 2265 | 2674 | 2710 |
| I-31 | 2254 | 2674 | 2727 |
| I-32 | 2282 | 2700 | 2743 |
| I-34 | 2252 | 2658 | 2692 |
| I-35 | 2269 | 2679 | 2739 |

The average pixel value data were analyzed with multiple linear regression to determine relationships between image pixel values of seed cotton fiber and the fiber properties.

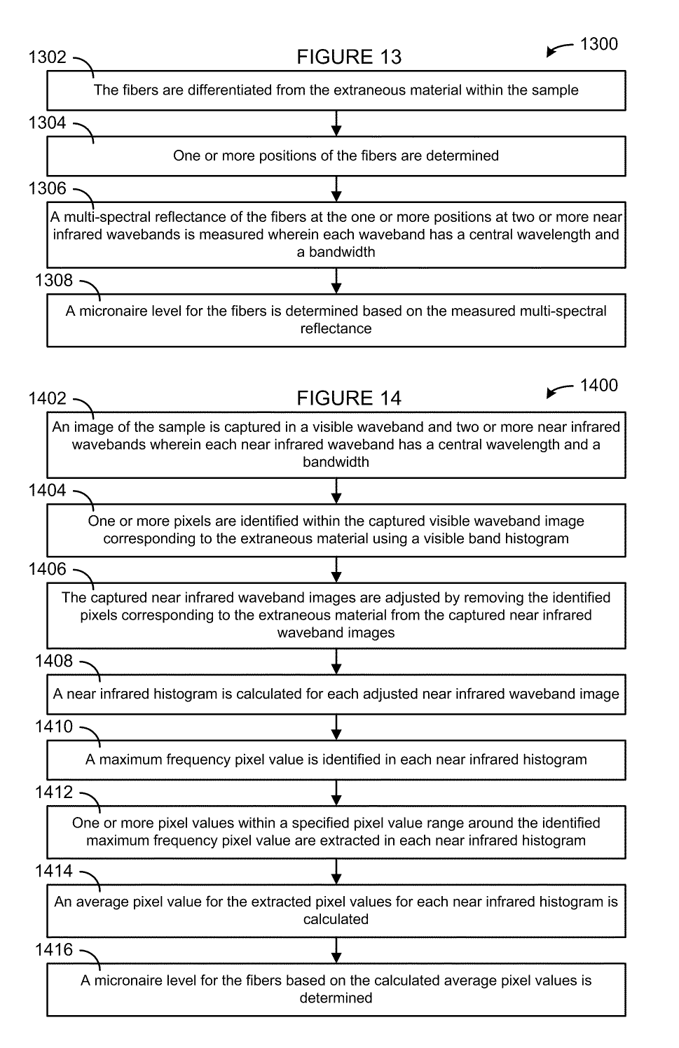

Now referring to FIG. 13, a flow chart of a computerized method 1300 for real-time in-situ measurement of a quality of fibers within a sample containing extraneous material in accordance with one embodiment of the present invention is shown. The fibers can be cotton, jute, flax, ramie, sisal, hemp, silk, wool, catgut, angora, mohair, alpaca or other natural fiber. The fibers are differentiated from the extraneous material within the sample in block 1302. One or more positions of the fibers are determined in block 1304. A multi-spectral reflectance of the fibers at the one or more positions at two or more near infrared wavebands is measured in block 1306. Each waveband has a central wavelength and a bandwidth. The two or more central wavelengths are within a range of approximately 1100 nm to 2400 nm, and the bandwidth is within a range of approximately 10 nm to 100 nm. A micronaire level for the fibers is determined based on the measured multi-spectral reflectance in block 1308. The foregoing steps are preformed in real-time in-situ using a processor.

The step of differentiating the fibers from the extraneous material within the sample may include the steps of capturing an image of the sample in a visible waveband, and identifying one or more pixels within the captured image corresponding to the extraneous material using a histogram. The multi-spectral reflectance can be determined by calculating a pixel value of the fibers within one or more regions of interest within an image recorded at each selected central wavelength. In addition, one or more pixels corresponding to the extraneous material can be removed from each image before the multi-spectral reflectance is determined. Furthermore, the method may include the step of illuminating the sample with one or more light sources.

In another embodiment, the two or more central wavelengths are selected from the group consisting of approximately 1450 nm, 1550 nm and 1600 nm, and the bandwidth is within a range of approximately 10 nm to 50 nm. The method may also include the steps of measuring a moisture content of the fibers, and adjusting the average pixel values based on the measured moisture content. In addition, the method may include the steps of physically extracting the sample and performing the foregoing steps during harvesting or processing of the fibers, or selecting the sample as the fibers pass within a range of a sensor during harvesting or processing of the fibers. Note that the extraction or selection steps can be performed randomly, periodically or continuously. Moreover, the fibers can be segregated in accordance to the determined micronaire level for the fibers.

In addition, the method may include the steps of performing the foregoing steps for multiple samples during harvesting while recording a geographic location where each sample was collected, and creating a fiber quality map corresponding to the determined micronaire level for the fibers at all the recorded geographic locations. Thereafter, one or more farm practices can be analyzed based on the fiber quality map, and at least one of the farm management practices can be adjusted to improve the micronaire level in future fibers.

Referring now to FIG. 14, a flow chart of a computerized method 1400 for real-time in-situ measurement of a quality of fibers within a sample containing extraneous material in accordance with one embodiment of the present invention is shown. The fibers can be cotton, jute, flax, ramie, sisal, hemp, silk, wool, catgut, angora, mohair, alpaca or other natural fiber. An image of the sample is captured in a visible waveband and two or more near infrared wavebands in block 1402. Each near infrared waveband has a central wavelength and a bandwidth. The two or more central wavelengths are within a range of approximately 1100 nm to 2400 nm, and the bandwidth is within a range of approximately 10 nm to 100 nm. One or more pixels are identified within the captured visible waveband image corresponding to the extraneous material using a visible band histogram in block 1404. The captured near infrared waveband images are adjusted by removing the identified pixels corresponding to the extraneous material from the captured near infrared waveband images in block 1406. A near infrared histogram is calculated for each adjusted near infrared waveband image in block 1408. A maximum frequency pixel value is identified in each near infrared histogram in block 1410. One or more pixel values within a specified pixel value range around the identified maximum frequency pixel value are extracted in each near infrared histogram in block 1412. An average pixel value for the extracted pixel values for each near infrared histogram is calculated in block 1414. A micronaire level for the fibers based on the calculated average pixel values is determined in block 1416. The foregoing steps are preformed in real-time in-situ using a processor.

In another embodiment, the two or more central wavelengths are selected from the group consisting of approximately 1450 nm, 1550 nm and 1600 nm, and the bandwidth is within a range of approximately 10 nm to 50 nm. The method may also include the steps of measuring a moisture content of the fibers, and adjusting the average pixel values based on the measured moisture content. In addition, the method may include the steps of physically extracting the sample and performing the foregoing steps during harvesting or processing of the fibers, or selecting the sample as the fibers pass within a range of a sensor during harvesting or processing of the fibers. Note that the extraction or selection steps can be performed randomly, periodically or continuously. Moreover, the fibers can be segregated in accordance to the determined micronaire level for the fibers.

In addition, the method may include the steps of performing the foregoing steps for multiple samples during harvesting while recording a geographic location where each sample was collected, and creating a fiber quality map corresponding to the determined micronaire level for the fibers at all the recorded geographic locations. Thereafter, one or more farm practices can be analyzed based on the fiber quality map, and at least one of the farm management practices can be adjusted to improve the micronaire level in future fibers.

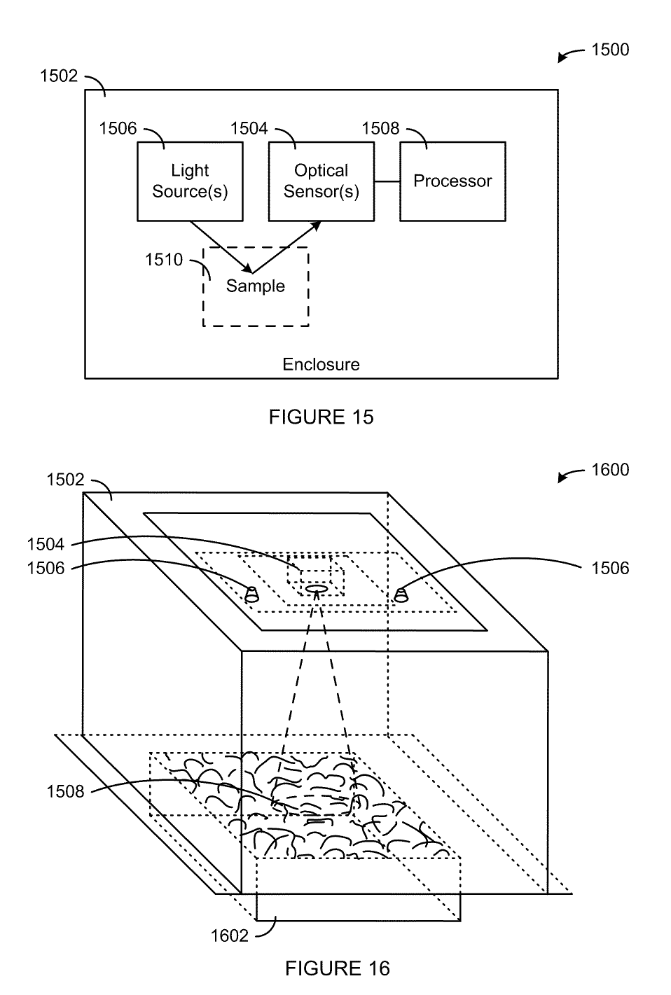

Now referring to FIG. 15, a block diagram of a multispectral sensor 1500 in accordance with one embodiment of the present invention is shown. The multispectral sensor 1500 includes a sensor enclosure 1502, one or more optical sensors 1504 disposed within the sensor enclosure 1502 to record one or more images of the sample 1510, one or more light sources 1506 disposed within the sensor enclosure 1502, and a processor 1508 communicably coupled to the one or more optical sensors 1504. The processor can be configured to perform the methods described above in reference with FIG. 13 or 14, or combinations thereof.

The processor 1508 may also be communicably coupled to the lights source(s) 1506 and other mechanisms known now or in the future to capture, manipulate, control and/or release the sample 1510. The processor 1508 can also be external to the enclosure 1502. The sensor 1500 can be powered by any power source known now or in the future that is suitable for the environment in which the sensor 1500 operates. Moreover, the sensor 1500 may also include a moisture sensor communicably coupled to the processor 1508 for measuring a moisture content of the fibers, or a geographic position sensor (e.g., GPS) for recording a geographic location where each sample 1510 is collected. The sensor 1500 can be installed on harvesters, fiber processing device/systems, ginning systems, or other similar equipment to measure cotton fiber quality and ultimately generate cotton fiber quality maps efficiently. The sensor 1500 can also be portable or modular.

Referring now to FIG. 16, is a schematic diagram of the multispectral sensor 1600 in accordance with another embodiment of the present invention is shown. The sensor includes (1) a device used to (a) differentiate cotton fiber from extraneous material and (b) determine the positions on a sample of cotton where multi-spectral measurements should be made, and (2) a device used to measure multi-spectral reflectance. Differentiating cotton fiber from extraneous material, extremely important when dealing with seed cotton, can be done with image-analysis based machine-vision technology. Once differentiation is done, the cotton fiber locations on the sample are evident, and then multispectral measurements can be made either with a mechanical movement of a diffuse-reflectance measurement system or processing of images from a camera based system. The multi-spectral measurement unit includes optical components, such as one or more light sources 1506, lenses and optical filters, and one or more opto-electronic detectors 1504. As the light sources illuminate the cotton fiber 1508, the measurement unit's detectors 1504 receive the energy at predetermined wavebands and generate corresponding electrical signals. Data acquisition and processing hardware and software control the entire process and record data from the measurement unit. The sensor 1600 can be installed on harvesters, fiber processing device/systems, ginning systems, or other similar equipment to measure cotton fiber quality and ultimately generate cotton fiber quality maps efficiently. The sensor 1600 can also be portable or modular.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 4,974,296: Apparatus for correcting irregularities in a textile strand.

United States Patent Application No. 20080307899: Pressure sensor.

WIPO Publication No. WO/2002/037054: Method and device for contactless measurement of a linear textile formation such as yarn etc.

Anthony, W. S. 1992. System for capturing, pressing and analyzing entrained solids such as cotton. U.S. Pat. No. 5,087,120.

Bradow, J. M. and G. H. Davidonis. 2000. Review quantitation of fiber quality and the cotton production-processing interface: a physiologist's perspective. J. Cotton Sci. 4:34-64.

Elms, M. K., C. J. Green, and P. N. Johnson. 2001. Variability of cotton yield and quality. Commun. Soil Sci. Plant Anal. 32(3&4): 351-368.

Ge, Y., J. A. Thomasson, and R. Sui. 2006. Variability of in-season soil moisture content and post-harvest cotton fiber quality in irrigated and dry-land cotton fields. In: Proc. Beltwide Cotton Conf., 2134-2142. Memphis, Tenn.: Nat. Cotton Council Am.

Ge, Y., J. A. Thomasson. 2006. Wavelet incorporated spectral analysis for soil property determination. Trans. ASABE 49(4): 1193-1201.

Ge, Y., C. L. S. Morgan, J. A. Thomasson, and T. Waiser. 2007. A new perspective to near-infrared reflectance spectroscopy: a wavelet approach. Trans. ASABE 50(1): 303-311.

Guo, W., S Maas, E. Hequet, R. Lascano, and J. Brightbill. 2004. Variability of cotton fiber quality in west Texas. In: Proc. Beltwide Cotton Conf., 2318-2325. Memphis, Tenn.: Nat. Cotton Council Am.

Johnson, R. M., J. M. Bradow, P. J. Bauer, and E. J. Sadler. 1998. Spatial variability of cotton fiber properties. In: Proc. Beltwide Cotton Conf., 1465-1466. Memphis, Tenn.: Nat. Cotton Council Am.

Montalvo, J, G. and T. M. Von Hoven. 2004. Update on micronaire, maturity and fineness research. In: Proc. Beltwide Cotton Conf., 2342-2349. Memphis, Tenn.: Nat. Cotton Council Am.

Morgan, C. L. S., S. Stanislav, J. Bynum, and J. A. Thomasson. 2008. The effect of soil spatial variability on cotton lint quality and profitability. In recorded presentations, Beltwide Cotton Conf. Available at http://ncc.confex.com/ncc/2008/techprogram/P8063.HTM. Memphis, Tenn.: National Cotton Council.

Morgan, G. D., A. E. MacGuidwin, J. Zhu, and L. K. Binning 2002a. Root lesion nematode (Pratylenchus penetrans) population dynamics over a three-year crop rotation. Agron. J. 94(5): 1146-1155.

Morgan, G. D., W. R. Stevenson, A. E. MacGuidwin, J. Zhu, and K. A. Kelling. 2002b. Plant pathogen population dynamics in potato fields. J. Nematology 34(3): 189-193.

Ping J. L., C. J. Green, and K. F. Bronson. 2004. Identification of relationships between cotton yield, quality, and soil properties. Agronomy J. 96(6): 1588-1597.

Sassenrath, G. F., E. R. Adams, and J. R. Williford. 2005. Rapid sampling system for determination of cotton fiber quality spatial variability. Applied Eng. Agric. 21(1): 9-14.

Thomasson, J. A., and S. A. Shearer. 1995. Correlation of NIR data with cotton quality characteristics. Trans. ASAE 38(4):1005-1010.

Wang, R. 2004. Site-specific prediction and measurement of cotton fiber quality. Unpublished dissertation, Mississippi State University.

What is claimed is:

1. A computerized method for real-time in-situ measurement of a quality of fibers within a sample containing extraneous material, comprising the steps of:
differentiating the fibers from the extraneous material within the sample;
determining one or more positions of the fibers;
measuring a multi-spectral reflectance of the fibers at the one or more positions at two or more near infrared wavebands wherein each waveband has a central wavelength and a bandwidth;
determining a micronaire level for the fibers based on the measured multi-spectral reflectance; and
wherein the foregoing steps are preformed in real-time in-situ using a processor.

2. The method as recited in claim 1, wherein the step of differentiating the fibers from the extraneous material within the sample comprises the steps of:
capturing an image of the sample in a visible waveband; and
identifying one or more pixels within the captured image corresponding to the extraneous material using a histogram.

3. The method as recited in claim 1, wherein:
the two or more central wavelengths are within a range of approximately 1100 nm to 2400 nm; and
the bandwidth is within a range of approximately 10 nm to 100 nm.

4. The method as recited in claim 1, wherein:
the two or more central wavelengths are selected from the group consisting of approximately 1450 nm, 1550 nm and 1600 nm; and
the bandwidth is within a range of approximately 10 nm to 50 nm.

5. The method as recited in claim 1, wherein the multi-spectral reflectance is determined by calculating a pixel value of the fibers within one or more regions of interest within an image recorded at each selected central wavelength.

6. The method as recited in claim 5, wherein one or more pixels corresponding to the extraneous material are removed from each image before the multi-spectral reflectance is determined.

7. The method as recited in claim 1, further comprising the step of:
physically extracting the sample and performing the foregoing steps during harvesting or processing of the fibers; or
selecting the sample as the fibers pass within a range of a sensor during harvesting or processing of the fibers.

8. The method as recited in claim 7, wherein the extraction or selection steps are performed randomly, periodically or continuously.

9. The method as recited in claim 7, further comprising the step of segregating the fibers in accordance to the determined micronaire level for the fibers.

10. The method as recited in claim 1, wherein the fibers comprise cotton, jute, flax, ramie, sisal, hemp, silk, wool, catgut, angora, mohair, alpaca or other natural fiber.

11. The method as recited in claim 1, further comprising the steps of illuminating the sample with one or more light sources.

12. The method as recited in claim 1, further comprising the steps of:
measuring a moisture content of the fibers; and
adjusting the measured multispectral reflectance based on the measured moisture content.

13. The method as recited in claim 1, further comprising the steps of:
performing the foregoing steps for multiple samples during harvesting while recording a geographic location where each sample is collected; and
creating a fiber quality map corresponding to the determined micronaire level for the fibers at all the recorded geographic locations.

14. The method as recited in claim 13, further comprising the steps of:
analyzing one or more farm practices based on the fiber quality map; and
adjusting at least one of the farm management practices to improve the micronaire level.

15. A multispectral sensor for real-time in-situ measurement of a quality of fibers within a sample containing extraneous material comprising:
a sensor enclosure;
one or more optical sensors disposed within the sensor enclosure to record one or more images of the sample;
one or more light sources disposed within the sensor enclosure; and
a processor communicably coupled to the one or more optical sensors, wherein the processor differentiates the fibers from the extraneous material within the sample, determines one or more positions of the fibers, measures a multi-spectral reflectance of the fibers at the one or more positions at two or more near infrared wavebands wherein each waveband has a central wavelength and a bandwidth, determines a micronaire level for the fibers based on the measured multi-spectral reflectance, and wherein the foregoing steps are preformed in real-time in-situ.

16. The sensor as recited in claim 15, wherein:
the two or more central wavelengths are within a range of approximately 1100 nm to 2400 nm; and
the bandwidth is within a range of approximately 10 nm to 100 nm.

17. The sensor as recited in claim 15, wherein:
the two or more central wavelengths are selected from the group consisting of approximately 1450 nm, 1550 nm and 1600 nm; and
the bandwidth is within a range of approximately 10 nm to 50 nm.

18. The sensor as recited in claim 15, further comprising:
a moisture sensor communicably coupled to the processor for measuring a moisture content of the fibers; and
wherein the processor adjusts the measured multi-spectral reflectance based on the measured moisture content.

19. The sensor as recited in claim 15, further comprising a geographic position sensor communicably coupled to the processor for recording a geographic location where each sample is collected.

20. The sensor as recited in claim 15, wherein the multispectral sensor is disposed within a harvester or a fiber processing device/system.

21. A computerized method for real-time in-situ measurement of a quality of fibers within a sample containing extraneous material, comprising the steps of:
capturing an image of the sample in a visible waveband and two or more near infrared wavebands wherein each near infrared waveband has a central wavelength and a bandwidth;
identifying one or more pixels within the captured visible waveband image corresponding to the extraneous material using a visible band histogram;
adjusting the captured near infrared waveband images by removing the identified pixels corresponding to the extraneous material from the captured near infrared waveband images;
calculating a near infrared histogram for each adjusted near infrared waveband image;
identifying a maximum frequency pixel value in each near infrared histogram;
extracting one or more pixel values within a specified pixel value range around the identified maximum frequency pixel value in each near infrared histogram;
calculating an average pixel value for the extracted pixel values for each near infrared histogram;
determining a micronaire level for the fibers based on the calculated average pixel values; and
wherein the foregoing steps are preformed in real-time in-situ using a processor.

22. The method as recited in claim 21, wherein:
the two or more central wavelengths are within a range of approximately 1100 nm to 2400 nm; and
the bandwidth is within a range of approximately 10 nm to 100 nm.

23. The method as recited in claim 21, wherein:
the two or more central wavelengths are selected from the group consisting of approximately 1450 nm, 1550 nm and 1600 nm; and
the bandwidth is within a range of approximately 10 nm to 50 nm.

24. The method as recited in claim 21, further comprising the steps of:
measuring a moisture content of the fibers; and
adjusting the average pixel values based on the measured moisture content.

25. The method as recited in claim 21, further comprising the steps of:
performing the foregoing steps for multiple samples during harvesting while recording a geographic location where each sample was collected; and
creating a fiber quality map corresponding to the determined micronaire level for the fibers at all the recorded geographic locations.

26. The method as recited in claim 25, further comprising the steps of:
analyzing one or more farm practices based on the fiber quality map; and
adjusting at least one of the farm management practices to improve the micronaire level.

27. A multispectral sensor for real-time in-situ measurement of a quality of fibers within a sample containing extraneous material comprising:
a sensor enclosure;
one or more optical sensors disposed within the sensor enclosure to capture an image of the sample in a visible waveband and two or more near infrared wavebands wherein each near infrared waveband has a central wavelength and a bandwidth;
one or more light sources disposed within the sensor enclosure; and
a processor communicably coupled to the one or more optical sensors, wherein the processor identifies one or more pixels within the captured visible waveband image corresponding to the extraneous material using a visible band histogram, adjusts the captured near infrared waveband images by removing the identified pixels corresponding to the extraneous material from the captured near infrared waveband images, calculates a near infrared histogram for each adjusted near infrared waveband image, identifies a maximum frequency pixel value in each near infrared histogram, extracts one or more pixel values within a specified pixel value range around the identified maximum frequency pixel value in each near infrared histogram, calculates an average pixel value for the extracted pixel values for each near infrared histogram, determines a micronaire level for the fibers based on the calculated average pixel values, and wherein the foregoing steps are preformed in real-time in-situ.

28. The sensor as recited in claim 27, wherein:
the two or more central wavelengths are within a range of approximately 1100 nm to 2400 nm; and
the bandwidth is within a range of approximately 10 nm to 100 nm.

29. The sensor as recited in claim 27, wherein:
the two or more central wavelengths are selected from the group consisting of approximately 1450 nm, 1550 nm and 1600 nm; and
the bandwidth is within a range of approximately 10 nm to 50 nm.

30. The sensor as recited in claim 27, further comprising:
a moisture sensor communicably coupled to the processor for measuring a moisture content of the fibers; and
wherein the processor adjusts the measured multi-spectral reflectance based on the measured moisture content.

31. The sensor as recited in claim 27, further comprising a geographic position sensor communicably coupled to the processor for recording a geographic location where each sample is collected.

32. The sensor as recited in claim 27, wherein the multispectral sensor is disposed within a harvester or a fiber processing device/system.
